(19) United States
(12) Patent Application Publication
(10) Pub. No.: US 2025/0247291 A1
(43) Pub. Date: Jul. 31, 2025

(54) SYSTEMS AND METHODS FOR IMPLEMENTING WRITING CONFIGURATION CHANGES IN A NON-REAL-TIME RADIO ACCESS NETWORK INTELLIGENCE CONTROLLER (NRT-RIC) ARCHITECTURE WITHIN A TELECOMMUNICATIONS NETWORK

(71) Applicant: RAKUTEN MOBILE, INC., Setagaya-ku, Tokyo (JP)

(72) Inventors: Pankaj Tanaji SHETE, Tokyo (JP); Awn MUHAMMAD, Tokyo (JP)

(73) Assignee: RAKUTEN MOBILE, INC., Setagaya-ku, Tokyo (JP)

(21) Appl. No.: 18/692,403

(22) PCT Filed: Dec. 27, 2023
(86) PCT No.: PCT/US2023/085994

§ 371 Date: Sep. 26, 2024

Related U.S. Application Data
(60) Provisional application No. 63/452,821, filed on Mar. 17, 2023.

(51) Int. Cl. H04L 41/0816; H04W 24/02

(52) U.S. Cl. CPC H04L 41/0816; H04W 24/02

(57) ABSTRACT

Systems and methods for implementing writing configuration changes in a non-real-time radio access network intelligence controller (NRT-RIC) architecture including a Service Management and Orchestration (SMO) framework and a NRT-RIC framework in an open radio access network (O-RAN) are provided. The method includes: receiving at least one request to write a configuration change to one or more O-RAN Operations and Maintenance (OAM) related functions; authorizing the at least one request to write a configuration change to the one or more O-RAN OAM-related functions from the rApp; validating information provided by the at least one request to write a configuration change to one or more O-RAN OAM-related functions; creating a job for writing the configuration changes based on the information provided by the at least one request to write a configuration change to one or more O-RAN OAM-related functions; and sending a job identifier comprising information about the job to the rApp.

### CROSS-REFERENCE TO RELATED APPLICATION(S)

This application is based on and claims priority from U.S. Provisional Patent Application No. 63/452,821, filed on Mar. 17, 2023, the disclosure of which is incorporated by reference herein in its entirety.

### TECHNICAL FIELD

Apparatuses and methods consistent with example embodiments of the present disclosure relate to implementing writing configuration changes in a non-real-time radio access network intelligence controller (NRT-RIC) architecture comprising a Service Management and Orchestration (SMO) framework and a NRT-RIC framework in an open radio access network (O-RAN).

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical node for hosting Radio Resource Control (RRC), Service Data Adaptation Protocol (SDAP), and/or Packet Data Convergence Protocol (PDCP) sublayers of the RAN. The DU is a logical node hosting Radio Link Control (RLC), Media Access Control (MAC), and Physical (PHY) sublayers of the RAN. The RU is a physical node that converts radio signals from antennas to digital signals that can be transmitted over the Fronthaul to a DU. Because these entities have open protocols and interfaces between them, they can be developed by different vendors.

FIG. 1 illustrates a related art O-RAN architecture. Referring to FIG. 1, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (NRT-RIC) and a near-real-time RIC (nRT-RIC).

The NRT-RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy-based guidance and enrichment across the A1 interface, which is the interface that enables communication between the NRT-RIC and the nRT-RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., nRT-RIC, O-RAN Centralized Unit (O-CU), O-RAN Distributed Unit (O-DU), etc.).

The nRT-RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The nRT-RIC uses the E2 interface to control the underlying RAN elements (E2 nodes/network functions (NFs)) over a near-real-time control loop. The nRT-RIC monitors, suspends/stops, overrides, and controls the E2 nodes (O-CU, O-DU, and O-eNB) via policies. For example, the nRT-RIC sets policy parameters on activated functions of the E2 nodes. Further, the nRT-RIC hosts xApps to implement functions such as quality of service (QOS) optimization, mobility optimization, slicing optimization, interference mitigation, load balancing, security, etc. The two types of RICs work together to optimize the O-RAN. For example, the NRT-RIC provides, over the A1 interface, the policies, data, and AI/ML models enforced and used by the nRT-RIC for RAN optimization, and the nRT-RIC returns policy feedback (i.e., how the policy set by the NRT-RIC works).

The SMO framework, within which the NRT-RIC is located, manages and orchestrates RAN elements. Specifically, the SMO manages and orchestrates what is referred to as the O-Ran Cloud (O-Cloud). The O-Cloud is a collection of physical RAN nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides infrastructure management services (IMS) and deployment management services (DMS).

The O-Cloud, on the other hand, is a cloud computing platform comprising a collection of physical infrastructure nodes that meet O-RAN requirements to host the relevant O-RAN functions (such as nRT-RIC, O-CU-CP, O-CU-UP, O-DU, etc.), the supporting software components (such as Operating System, Virtual Machine Monitor, Container Runtime, etc.) and the appropriate management and orchestration functions.

The SMO framework, within which the NRT-RIC is located, manages and orchestrates RAN elements. The SMO performs the following services (i.e., management and orchestration of RAN elements through four key interfaces to the O-RAN Elements: the A1 Interface between the NRT-RIC in the SMO and the nRT-RIC for RAN Optimization; the O1 Interface between the SMO and the O-RAN Network Functions for FCAPS support; in the case of a hybrid model, an Open Fronthaul M-plane interface between SMO and O-RU for FCAPS support; the O2 Interface between the SMO and the O-Cloud to platform resources and workload management.

In the related art, there is no standardized communication between an rApp sending at least one request to write a configuration change to one or more O-RAN Operations and Maintenance (OAM) related functions via an R1 interface between the rApp and the non-anchored functions of the SMO framework and the NRT-RIC framework.

As a result, communication between an rApp requesting write request for changing a configuration to one or more O-RAN Operations and Maintenance (OAM) related functions and the non-anchored functions of the SMO framework and the NRT-RIC framework may not be able to facilitate the multivendor operability required in the O-RAN system.

### SUMMARY

According to embodiments, apparatuses and methods are provided for implementing writing configuration changes in a non-real-time radio access network intelligence controller (NRT-RIC) architecture including a Service Management and Orchestration (SMO) framework and a NRT-RIC framework in an open radio access network (O-RAN), wherein the implementation of the writing configuration changes allows a network operator to effectively manage (standardize) rApps from multiple vendors to facilitate the multivendor operability required in the NRT-RIC architecture of the O-RAN.

To this end, the implementation of writing configuration changes comprises authorization and validation to create a job (e.g., a job ticket) for writing a configuration change to one or more O-RAN Operations and Maintenance (OAM) related functions.

As a result, based on the authorization and validation to create a job (e.g., a job ticket) the communication between an rApp requesting write request for changing a configuration to one or more O-RAN Operations and Maintenance (OAM) related functions and the non-anchored functions of the SMO framework and the NRT-RIC framework is standardized.

An apparatus includes a non-real-time radio access network intelligence controller (NRT-RIC) configured to receive, from an rApp via an R1 interface between the rApp and the NRT-RIC framework, at least one request to write a configuration change to one or more O-RAN Operations and Maintenance (OAM) related functions. The apparatus authorizes the at least one request to write a configuration change to the one or more O-RAN OAM-related functions from the rApp. The apparatus, based on the authorizing, validates information provided by the at least one request to write a configuration change to one or more O-RAN OAM-related functions. The apparatus, based on the validating, creates a job for writing the configuration changes based on the information provided by the at least one request to write a configuration change to one or more O-RAN OAM-related functions. The apparatus, based on job creating, sends via the NRT-RIC framework and the via an R1 interface, a job identifier comprising information about the job to the rApp.

According to an embodiment, a method for implementing writing configuration changes in a non-real-time radio access network intelligence controller (NRT-RIC) architecture including a Service Management and Orchestration (SMO) framework and a NRT-RIC framework in an open radio access network (O-RAN) is provided. The method includes: receiving, from an rApp via an R1 interface between the rApp and the NRT-RIC framework, at least one request to write a configuration change to one or more O-RAN Operations and Maintenance (OAM) related functions; authorizing, by the NRT-RIC framework, the at least one request to write a configuration change to the one or more O-RAN OAM-related functions from the rApp; based on the authorizing, validating, by the one or more O-RAN OAM-related functions, information provided by the at least one request to write a configuration change to one or more O-RAN OAM-related functions; based on the validating, creating, by the one or more O-RAN OAM-related functions, a job for writing the configuration changes based on the information provided by the at least one request to write a configuration change to one or more O-RAN OAM-related functions; and based on job creating, sending, by the one or more O-RAN OAM-related functions via the NRT-RIC framework and the via an R1 interface, a job identifier including information about the job to the rApp.

According to an embodiment, a non-transitory computer-readable recording medium having recorded thereon instructions executable by at least one processor to perform a method implementing writing configuration changes in a non-real-time radio access network intelligence controller (NRT-RIC) architecture including a Service Management and Orchestration (SMO) framework and a NRT-RIC framework in an open radio access network (O-RAN) is provided. The method includes: receiving, from an rApp via an R1 interface between the rApp and the NRT-RIC framework, at least one request to write a configuration change to one or more O-RAN Operations and Maintenance (OAM) related functions; authorizing, by the NRT-RIC framework, the at least one request to write a configuration change to the one or more O-RAN OAM-related functions from the rApp; based on the authorizing, validating, by the one or more O-RAN OAM-related functions, information provided by the at least one request to write a configuration change to one or more O-RAN OAM-related functions; based on the validating, creating, by the one or more O-RAN OAM-related functions, a job for writing the configuration changes based on the information provided by the at least one request to write a configuration change to one or more O-RAN OAM-related functions; and based on job creating, sending, by the one or more O-RAN OAM-related functions via the NRT-RIC framework and the via an R1 interface, a job identifier including information about the job to the rApp.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture in the related art;

FIG. 2 is a diagram of an example environment in which systems and/or methods, described herein, may be implemented;

FIG. 3 is a diagram of example components of a device according to an embodiment;

FIG. 4 illustrates the NRT-RIC architecture comprising unanchored functions of the SMO Framework and NRT-RIC Framework within an O-RAN according to an embodiment;

FIG. 5 illustrates an operational flow between an rApp and non-anchored functions of the SMO Framework and NRT-RIC Framework according to an embodiment;

FIG. 6 illustrates a method for implementing writing configuration changes in an SMO framework comprising a NRT-RIC framework in an open radio access network O-RAN according to an embodiment;

FIG. 7 illustrate a method for authorizing at least one request to write a configuration change to one or more O-RAN OAM-related functions from an rApp according to an embodiment;

FIG. 8 illustrates a method for validating the information provided by at least one request to write a configuration change to one or more O-RAN OAM-related functions according to an embodiment;

FIG. 9 illustrates a method for creating a job for writing the configuration changes according to an embodiment;

FIG. 10 illustrates a method for receiving at least one job query via an R1 interface within the O-RAN architecture between rApps and the NRT-RIC framework according to an example embodiment; and

FIG. 11 an operational flow between an rApp between and an rApp and a NRT-RIC to an example embodiment.

### DETAILED DESCRIPTION

The following detailed description of exemplary embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

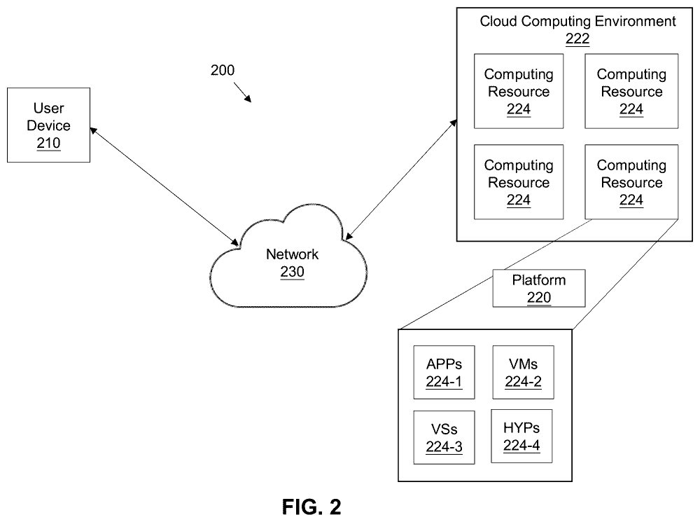

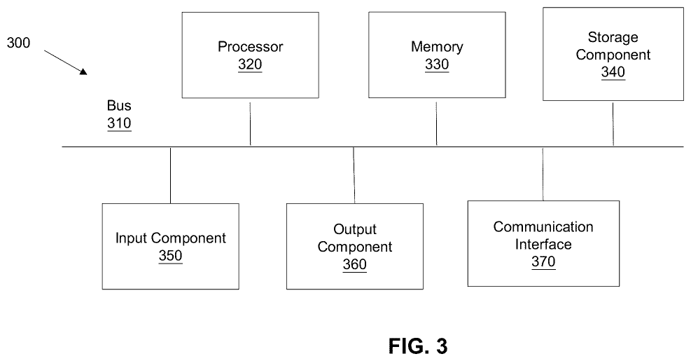

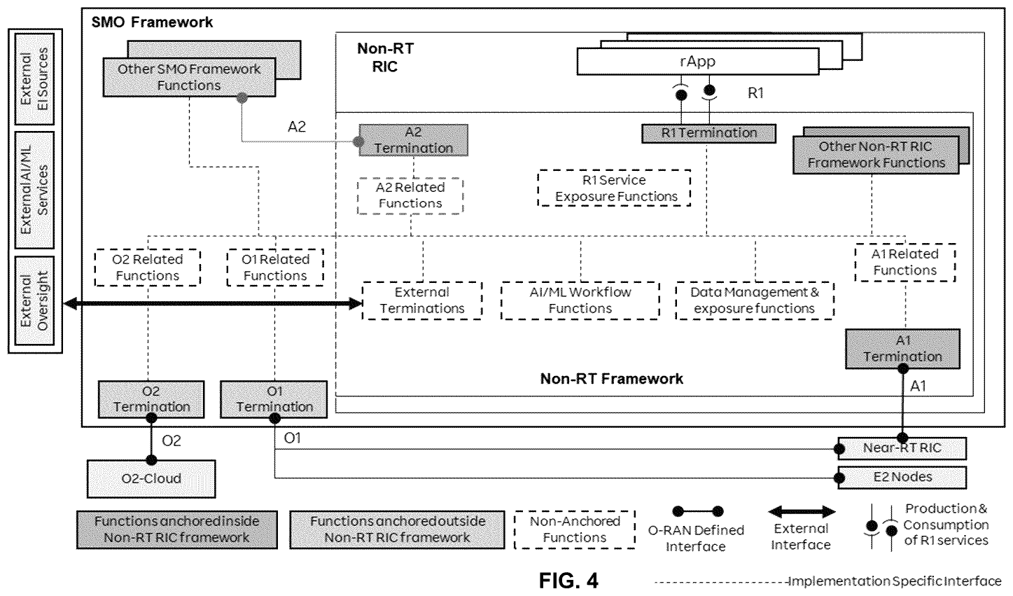

FIG. 2 is a diagram of an example environment 200 in which systems and/or methods, described herein, may be implemented. As shown in FIG. 3, environment 200 may include a user device 210, a platform 220, and a network 220. Devices of environment 200 may interconnect via wired connections, wireless connections, or a combination of wired and wireless connections. In embodiments, any of the functions and operations described with reference to FIGS. 4 through 10 below may be performed by any combination of elements illustrated in FIG. 3.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc., services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate the need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 220 includes one or more wired and/or wireless networks. For example, network 220 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300. Device 300 may correspond to user device 210 and/or platform 220. As shown in FIG. 3, device 300 may include a bus 310, a processor 320, a memory 320, a storage component 330, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 320 includes a random-access memory (RAM), a read-only memory (ROM), and/or another type of dynamic or static storage device (e.g., a flash memory, a magnetic memory, and/or an optical memory) that stores information and/or instructions for use by processor 320.

Storage component 330 stores information and/or software related to the operation and use of device 300. For example, storage component 330 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 320 and/or storage component 330. A computer-readable medium is defined herein as a non-transitory memory device. A memory device includes memory space within a single physical storage device or memory space spread across multiple physical storage devices.

Software instructions may be read into memory 320 and/or storage component 330 from another computer-readable medium or from another device via communication interface 370. When executed, software instructions stored in memory 320 and/or storage component 330 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the operations or processes of FIGS. 4 to 10 may be implemented by or using any one of the elements illustrated in FIGS. 2 to 3.

FIG. 4 illustrates the NRT-RIC architecture (or platform) and the rApp hosted by the NRT-RIC with regard to the R1 interface within the SMO framework system architecture and the O1, O2, A1 interface within an O-RAN according to an embodiment.

Referring to FIG. 4, the NRT-RIC represents a subset of functionalities of the SMO framework (i.e., functions anchored inside the NRT-RIC framework, functions anchored outside the NRT-RIC framework and non-anchored (i.e., unanchored functions). The NRT-RIC can access other SMO framework functionalities and thereby influence (i.e., controls and/or executes) what is carried across at least of one of an O1 interface, Fronthaul M-Plane interface and O2 interface for O-CU, O-DU, O-RU, near-RT RIC, etc. (e.g., performing configuration management (CM) and/or performance management (PM)).

The NRT-RIC includes an NRT-RIC framework. The NRT-RIC framework, among a plurality of other functions, includes R1 service management and exposure (SME) functions that handle R1 services provided in accordance with the embodiments. For example, the SME functions perform the authorization and authentication in the role of a gatekeeper within the NRT-RIC framework. Moreover, the SME functions may collaborate with non-anchored (i.e., unanchored functions) to perform the authorization and authentication of rApp or requests of rApps such as a writing configuration changes to one or more O-RAN Operations and Maintenance (OAM) related functions.

In general, the NRT-RIC functions within the NRT-RIC framework support the authorization, authentication, registration, discovery, communication support, etc. for rApps.

NRT-RIC Applications (rApps) are applications that leverage the functionalities available in the NRT-RIC framework and/or SMO Framework to provide value-added services related to RAN operation and optimization. The scope of rApps includes, but is not limited to, radio resource management, data analytics, etc., and enrichment of information. For example, the rApp may request to write a configuration change to one or more O-RAN OAM-related functions.

To this end, the NRT-RIC framework produces and/or consumes R1 services according to example embodiments via an R1 interface. The R1 interface terminates in an R1 termination of the NRT-RIC framework. The R1 termination connects to the NRT-RIC framework and the rApps via the R1 interface and enables the NRT-RIC framework and rApps to exchange messages/data (i.e., requests and responses comprising of data models) to access the R1 services via the R1 interface.

Moreover, the NRT-RIC framework comprises A1-related functions. The A1-related functions of the NRT-RIC framework support, for example, A1 logical termination, A1-policy coordination and catalog, A1-EI coordination and catalog, etc.

The data management and exposure services within the NRT-RIC framework deliver data created or collected by data producers to data consumers according to their needs (e.g., function management (FM)/configuration management (CM)/production management (PM) data to rApps or CM changes from rApps to the O-RAN via the O1 interface).

The NRT-RIC framework further comprises External Terminations. The External Terminations, for example, support an exchange of data between the NRT-RIC framework and external AI/ML functions, Enrichment Information (EI) Sources, or an External Oversight.

Within the NRT-RIC framework, the AI/ML workflow services provide access to AI/ML workflow. For example, the AI/ML workflow services may assist in training models, monitoring, etc. the deployed AI/ML models in NRT-RIC.

Moreover, the NRT-RIC framework comprises A2-related functions that support, for example, A2 logical termination, A2-Policy coordination and catalog, etc.

Still referring to FIG. 4, within the NRT-RIC framework, the R1 interface is an open logical interface in the O-RAN architecture between the rApps and the NRT-RIC framework of the NRT-RIC. The R1 interface supports the exchange of control signaling information and the collection and delivery of data between endpoints. The R1 interface enables, for example, multi-vendor rApps to consume and/or produce the R1 services.

The R1 interface is independent of specific implementations of the SMO and NRT-RIC framework of the NRT-RIC. The R1 interface is defined in an extensible way that enables new services and data types to be added without needing to change the protocols or the procedures.

In particular, the R1 interface facilitates the interconnection between rApps and the NRT-RIC framework supplied by different vendors (i.e., facilitates interconnection in a multi-vendor environment). To this end, the R1 interface provides a level of abstraction between the rApps and NRT-RIC Framework and/or SMO Framework.

A framework of an R1 application protocol according to an embodiment specifies R1 services and related service procedures as well as API definitions.

For example, R1 services and related service procedures may include R1-Service Management and Exposure (SME) services, R1-Data Management & Exposure (DME) services, R1-A1 services, R1-O1 services, R1-O2 Data services, R1-AIML services, R1 services via the Fronthaul M-Plane, etc.

To this end, logical functions that produce the RAN OAM-related services which are exposed to rApps via the R1 interface are called O-RAN Operations and Maintenance (OAM) related functions. For example, O-RAN OAM-related functions may realize the producing O-RAN OAM-related services which are exposed to rApps via the R1 interface, wherein at least one of the services may comprise performing CM conflict mitigation and interfacing, for example, with near-RT RICs and E2 nodes through an O1 termination, with the O-RUs through Open Fronthaul M-plane termination and the with the RAN-specific slice management functionality in the SMO framework.

The interfacing with near-RT RICs and E2 nodes through an O1 termination may comprise O-RAN OAM-related functions to receive fault notifications and obtain alarm list from near-RT RICs and E2 nodes (i.e., E2 O-RUs), provision configuration changes to near-RT RICs and E2 nodes, collect performance data from near-RT RICs and E2 nodes.

The interfacing with the O-RUs through Open Fronthaul M-plane termination may comprise RAN OAM-related functions to receive fault notifications and obtain alarm list from the O-RUs, provision configuration changes to the O-RUs, collect performance data from the O-RUs.

The interfacing with the RAN-specific slice management functionality in the SMO framework may comprise RAN OAM-related functions to provision configuration changes, related to RAN-specific network slicing and collect performance data related to RAN-specific network slicing.

Hereinbelow, the rApp may use the R1 interface (between rApp and RAN OAM-related functions) for provisioning (e.g., writing) configuration changes to O-RUs, Near-RT RICs and E2 nodes (O-CU, O-DU) via the O1 termination and/or O-RUs through the Open Fronthaul M-plane termination.

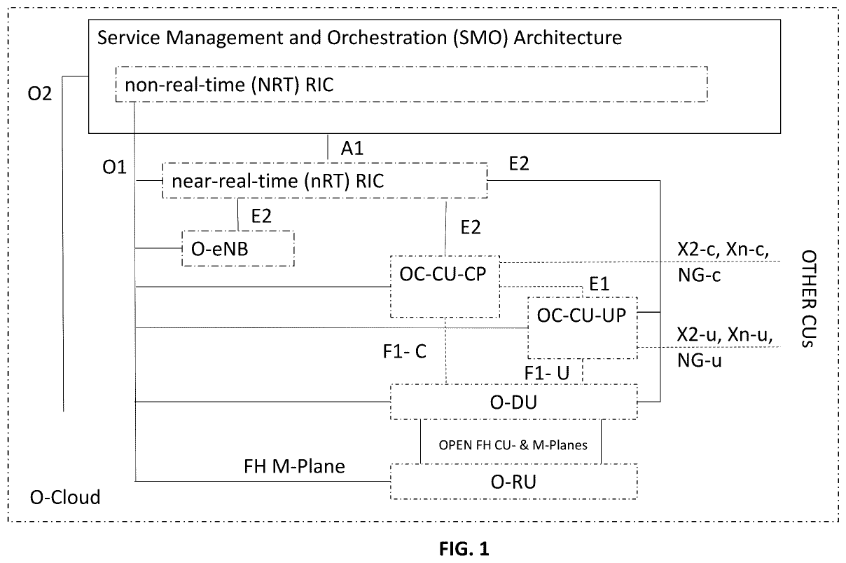

In the related art according to FIG. 1, communication of an rApp and unanchored functions (including RAN OAM-related functions) via the R1 interface (between rApp and RAN OAM-related functions) for provisioning (e.g., writing) configuration changes to O-RUs, Near-RT RICs and E2 nodes (O-CU, O-DU) via the O1 termination and/or O-RUs through the Open Fronthaul M-plane termination is not standardized.

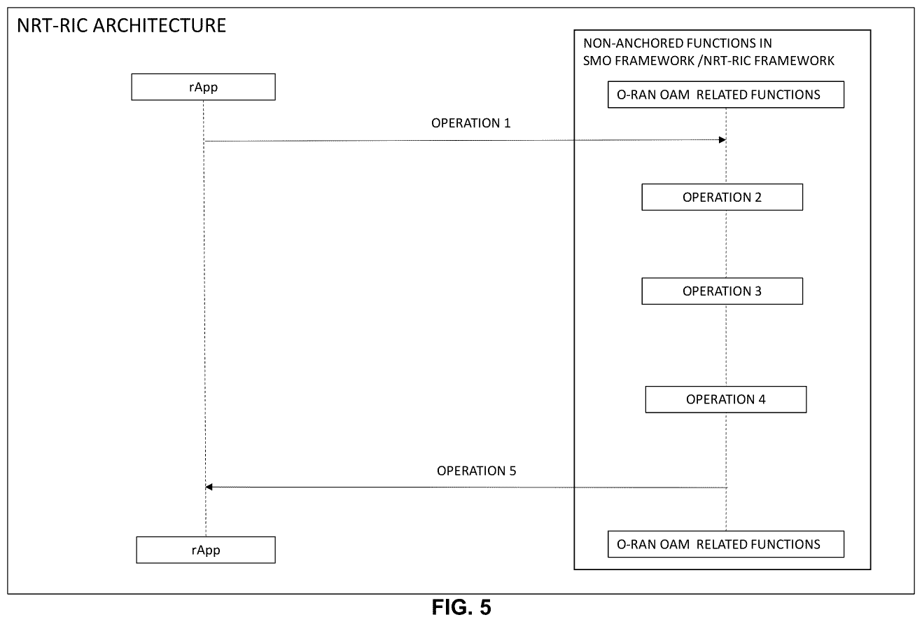

FIG. 5 illustrates a operational flow between an rApp and the unanchored functions of the SMO Framework and NRT-RIC Framework according to an embodiment.

Referring to FIG. 5, the operational flow between the rApp and the unanchored functions of the SMO Framework and NRT-RIC Framework solves the problem to standardize the operations for an rApp to write configuration change information to the configuration management service producer (i.e., the one or more RAN OAM-related functions as set forth in FIG. 4).

To this end, in FIG. 5, the operational flow is performed by an rApp in the role of CM Service Consumer that request a configuration change information (e.g., at least one request to write a configuration change to one or more O-RAN OAM-related functions) pertaining to one or more managed entities (e.g., to O-RUs, Near-RT RICs and E2 nodes (O-CU, O-DU) via the O1 termination and/or O-RUs through the Open Fronthaul M-plane termination).

According to an embodiment, the rApp may be deployed to the NRT-RIC framework and authorized to write the configuration change information to the NRT-RIC framework via the R1 interface.

Moreover, according to another embodiment, the rApp may determine the need to write the configuration change information based on data consumed via the R1 interface from the NRT-RIC framework and unanchored (i.e., non-anchored) functions such as, for example, one or more O-RAN OAM-related functions.

In operation 1, the rApp requests to write the configuration changes (e.g., a message relating to writing configuration changes that provides information to the RAN OAM-related functions) to the NRT-RIC framework (i.e., a NRT-RIC hosting the NRT-RIC framework).

For example, the rApp may provide an rApp identifier, optional query criteria and information about the managed entities and the desired configuration changes information, etc. On the other side, in operation 1, the NRT-RIC framework receives, via the R1 interface between the rApp and the NRT-RIC framework (i.e., a NRT-RIC hosting the NRT-RIC framework), at least one request to write a configuration change to one or more O-RAN OAM-related functions.

In operation 2, the O-RAN OAM-related functions (i.e., the NRT-RIC) check whether the rApp is authorized to initiate the request to write a configuration change to one or more O-RAN OAM-related functions. For example, the authorization and authentication may be performed in collaboration with at least one SME service function that acts as a gatekeeper. In an embodiment, the O-RAN OAM-related functions may not know the rApp, as a result, the O-RAN OAM-related functions may collaborate with at least one SME function to authenticate the rApp and verify that the rApp is authorized to request write configuration changes to O-RAN nodes (e.g., to O-RUs, Near-RT RICs and E2 nodes (O-CU, O-DU) via the O1 termination and/or O-RUs through the Open Fronthaul M-plane termination).

In operation 3, the O-RAN OAM-related functions (i.e., the NRT-RIC) validate the information provided by the request to write a configuration change to one or more O-RAN OAM functions. For example, in an embodiment, the validating may comprise validating the syntax and message content of the request, as defined by O-RAN and other subsequent standard organizations, such as, for example, 3GPP, ITU-T, etc. Moreover, in another embodiment, the validating may comprise resolving conflicts between requests from multiple rApps, which may include similar target nodes (i.e., for similar O-RAN nodes) with or without similar configurations that may have similar impacts on the operations of, for example, an E2 open radio unit (i.e., E2/O-RU).

According to an embodiment, the O-RAN OAM-related function may not validate, for example, whether or not the E2 Node or the O-RU are allowed for certain configuration changes and/or are either available or exist with the O-RAN. According to this embodiment, the details may be captured in other O-RAN OAM-related services that focus on the production of data based on retrieval requests for configuration schemes of E2 Nodes and/or the O-RUs within the O-RAN.

In operation 4, the O-RAN OAM-related functions (i.e., the NRT-RIC) create a job for writing the configuration changes based on the information provided by at least one request to write a configuration change to one or more O-RAN OAM-related functions (i.e., create a Write configuration job from the information provided in the Write configuration changes request).

According to an embodiment, the RAN OAM-related function may create the job irrespective of whether an E2/O-RU node is available or not. To this end, based on the information provided by at least one request to write a configuration change, determine, by one or more O-RAN OAM-related functions (e.g., by an O-RAN OAM-related services that focus on the production of data based on retrieval requests for configuration schemes of E2 Nodes and/or the O-RUs within the O-RAN), the availability of the E2 node and/or the O-RU (E2/O-RU) to write the configuration change; and create, by the one or more O-RAN OAM-related functions, the job for writing the configuration changes based on the information provided by the at least one request to write a configuration change for the E2/O-RU independent of the availability of the E2/O-RU.

In operation 5, the O-RAN OAM-related functions (i.e., the NRT-RIC) respond to the rApp with information about the created job. For example, the O-RAN OAM-related functions may respond with a job identifier (e.g., a job ticket). To this end, based on job creating, the one or more O-RAN OAM-related functions may send the job identifier comprising information about the job to the rApp via the NRT-RIC framework and the via the R1 interface.

According to an embodiment, the rApp may use the information about the created job for querying or receiving notifications about the status and/or a result of the requested configuration change.

To this end, based on sending a job identifier comprising information about the job to the rApp, one or more O-RAN OAM-related functions may receive at least one job query from the rApp. The rApp may send the job query via the R1 interface within the O-RAN architecture between rApps and the NRT-RIC framework, wherein the at least one job query may be at least one query for a notification of job status and for a query of a job result of the requested configuration change.

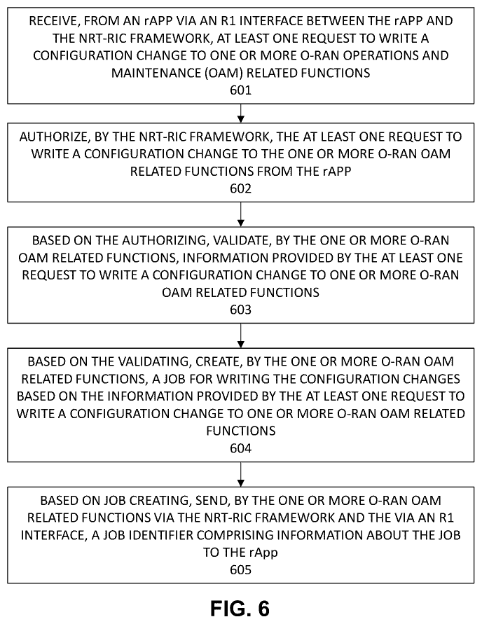

FIG. 6 illustrates a method for implementing writing configuration changes in an SMO framework comprising a NRT-RIC framework in an open radio access network O-RAN according to an embodiment.

Referring to FIG. 6, in step 601, the O-RAN Operations and Maintenance (OAM) functions (i.e., a NRT-RIC) receive at least one request to write a configuration change to one or more O-RAN Operations and Maintenance (OAM) functions from an rApp via an R1 interface between the rApp and the NRT-RIC framework.

According to an embodiment, at least one request to write a configuration change to one or more O-RAN OAM-related functions comprises at least one information of an rApp identifier and one or more desired configuration changes for one or more O-RAN nodes within the O-RAN.

In step 602, the NRT-RIC framework (e.g., the one or more O-RAN Operations OAM-related functions in collaboration with at least one SME service function that acts as a gatekeeper) authorizes at least one request to write a configuration change to the one or more O-RAN OAM-related functions from the rApp.

In step 603, based on the authorization, the one or more O-RAN OAM-related functions validate information provided by at least one request to write a configuration change to one or more O-RAN OAM-related functions.

In step 604, based on the validation, the one or more O-RAN OAM-related functions create a job for writing the configuration changes based on the information provided by at least one request to write a configuration change to one or more O-RAN OAM-related functions.

In step 605, based on job creation, the one or more O-RAN OAM-related functions send, via the NRT-RIC framework and the via an R1 interface, a job identifier comprising information about the job to the rApp.

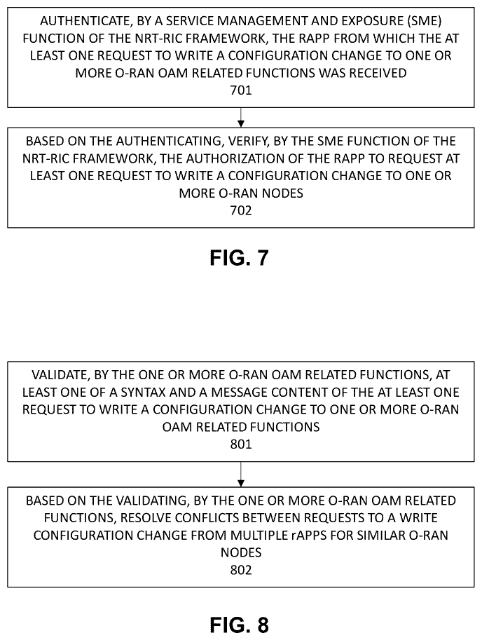

FIG. 7 illustrate a method for authorizing at least one request to write a configuration change to one or more O-RAN OAM-related functions from an rApp according to an embodiment.

Referring to the FIG. 7, in step 701, a service management and exposure (SME) function of the NRT-RIC framework (i.e., a NRT-RIC) authenticates the rApp from which at least one request to write a configuration change to one or more O-RAN OAM-related functions was received.

In step 702, based on the authenticating, the SME function of the NRT-RIC framework verifies the authorization of the rApp to request at least one request to write a configuration change to one or more O-RAN nodes.

According to an embodiment, the authorization and authentication may be performed in collaboration with at least one SME service function that acts as a gatekeeper. In another embodiment, the O-RAN OAM-related functions may not know the rApp, as a result, the O-RAN OAM-related functions may collaborate with at least one SME function to authenticate the rApp and verify that the rApp is authorized to request write configuration changes to O-RAN nodes (e.g., to O-RUs, Near-RT RICs and E2 nodes (O-CU, O-DU) via the O1 termination and/or O-RUs through the Open Fronthaul M-plane termination).

FIG. 8 illustrates a method for validating the information provided by the at least one request to write a configuration change to one or more O-RAN OAM-related functions according to an embodiment.

Referring to FIG. 8, in step 801, one or more O-RAN OAM-related functions (i.e., a NRT-RIC) validate at least one of a syntax and a message content of at least one request to write a configuration change to one or more O-RAN OAM-related functions.

In step 802, based on the validating, one or more O-RAN OAM-related functions resolve conflicts between requests to a write configuration change from multiple rApps for similar O-RAN nodes.

For example, in an embodiment, the validating may comprise validating the syntax and message content of the request, as defined by O-RAN and other subsequent standard organizations, such as, for example, 3GPP, ITU-T, etc.

Moreover, according to another embodiment, the validating may comprise resolving conflicts between requests from multiple rApps, which may include similar target nodes (i.e., for similar O-RAN nodes) with or without similar configurations that may have similar impacts on the operations of, for example, an E2 open radio unit (i.e., E2/O-RU).

According to an yet another embodiment, the O-RAN OAM-related function may not validate, for example, whether or not the E2 Node or the O-RU are allowed for certain configuration changes and/or are either available or exist with the O-RAN. According to this embodiment, the details may be captured in other O-RAN OAM-related services that focus on the production of data based on retrieval requests for configuration schemes of E2 Nodes and/or the O-RUs within the O-RAN.

FIG. 9 illustrates a method for creating a job for writing the configuration changes according to an embodiment.

Referring to FIG. 9, in step 901, based on the information provided by the at least one request to write a configuration change, one or more O-RAN OAM-related functions (e.g., another other O-RAN OAM-related services that focus on the production of data based on retrieval requests for configuration schemes of E2 Nodes and/or the O-RUs within the O-RAN) (i.e., a NRT-RIC) determines the availability of an E2 node and/or an open radio unit (E2/O-RU) to write the configuration change.

In step 902, one or more O-RAN OAM-related functions create the job for writing the configuration changes based on the information provided by the at least one request to write a configuration change for the E2/O-RU independent of the availability of the E2/O-RU.

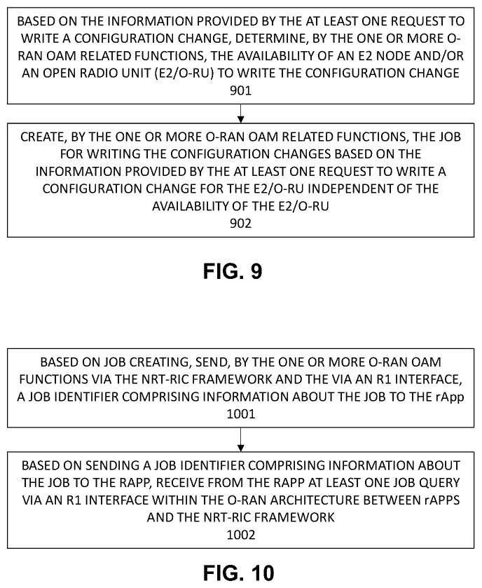

FIG. 10 illustrates a method for receiving at least one job query via an R1 interface within the O-RAN architecture between rApps and the NRT-RIC framework according to an example embodiment.

Referring to FIG. 10, in step 1001, based on job creating, one or more O-RAN OAM-related functions send a job identifier comprising information about the job to the rApp via the NRT-RIC framework and the via an R1 interface.

In step 1002, based on sending a job identifier comprising information about the job to the rApp, the one or more O-RAN OAM-related functions (i.e., a NRT-RIC) receive at least one job query via an R1 interface from the rApp.

According to an embodiment, the rApp may send the job query via the R1 interface within the O-RAN architecture between rApps and the NRT-RIC framework, wherein the at least one job query may be at least one query for a notification of job status and for a query of a job result of the requested configuration change.

According to embodiments illustrated in FIGS. 5 to 10, systems and methods are provided for implementation of the writing configuration changes to allow a network operator to effectively manage (standardize) rApps from multiple vendors to facilitate the multivendor operability required in the NRT-RIC architecture of the O-RAN.

As a result, the rApps from multiple vendors are allowed to request to write configuration changes to one or more O-RAN OAM functions from multiple vendors (i.e., to O-RAN nodes from multiple vendors) thereby optimizing the multivendor operability though out the O-RAN.

An example use case according to an embodiment may be as follows:

| | |
|---|---|
| Reason for | Introduction of RAN OAM-Related use |
| Change: | case for Writing configuration changes |
| Summary of | Description of RAN OAM-Related use |
| change: | case for Writing configuration changes |
| Consequences | Absence of use case on RAN |
| if not | OAM Related CM procedure for Writing |
| approved: | configuration changes for R1 interface |

### 8 Use Cases for RAN OAM-Related Services

### <<Start of Change #1>>>

### 8.x RAN OAM-Related Use Case Y: Writing Configuration Changes.

### 8.x.1 Overview

This use-case allows an rApp acting as a CM Service Consumer to write information pertaining to the configuration changes of one or more managed entities.

### 8.x.2 Background and Goal of the Use-Case

An rApp acting as a CM Service Consumer can write information pertaining to the configuration changes of one or more managed entities from the Configuration management Service Producer.

### 8.x.3 Entities/Resources Involved in the Use-Case

1) RAN OAM-related functions as Configuration Management Service Producer
a. receives the Write Configuration Changes request to write configuration change information related to one or more managed entities.
b. provides the response of success or failure result to the Write Configuration request.
2) rApp
   a. supports functionality to initiate Write Configuration changes request procedure to write the configuration change information.

### 8.x.4 Solutions

### 8.x.4.1 Write Configuration Changes Information

TABLE 8.x.4.1-1
Write Configuration changes information use-case.

| | | |
|---|---|---|
| | | << Uses>> |
| Use Case | | Related |
| Stage | Evolution/Specification | use case |

| | |
|---|---|
| Goal | The rApp writes configuration change information to the |
| | configuration management service Producer. |
| Actors and | rApp in the role of CM Service Consumer that request |
| Roles | the configuration change information pertaining to one |
| | or more managed entities. |
| | RAN OAM-related functions in the role of |
| | Configuration Management service Producer that |
| | provision the requested configuration change |
| | information. |
| Assumptions | n/a |
| Preconditions | The rApp is deployed and authorized to write the |
| | configuration change information. |
| Begins when | The rApp determines the need to write the configuration |
| | change information. |
| Step 1 (M) | The rApp requests Write Configuration Changes to write |
| | the configuration change information to the RAN OAM- |
| | related functions by providing the rAppId, optional query |
| | criteria and information about the managed entities, along |
| | with the desired configuration changes information. |
| Step 2 (M) | The RAN OAM-related functions check whether the rApp |
| | is authorized to request Write Configuration changes. |
| Step 3 (M) | The RAN OAM-related functions validate the information |
| | provided with Write Configuration changes. |
| Step 4 (M) | The RAN OAM-related functions respond to the rApp |
| | with, |
| | a success result only if all the desired configuration |
| | changes written in mentioned managed entities. |
| | a partial success result if partial but not all desired |
| | configuration changes written in mentioned |
| | managed entities. |
| | a failure if all desired configuration changes not |
| | written in mentioned managed entities because of a |
| | specified or unspecified reason. |
| Ends when | The rApp was able to receive the configuration response. |
| Exceptions | n/a |
| Post | n/a |
| Conditions | |
| Traceability | TBD |

```
@startuml
!pragma teoz true
skinparam ParticipantPadding 70
skinparam BoxPadding 10
skinparam defaultFontSize 12
skinparam lifelineStrategy solid
box “Non-RT RIC” #whitesmoke
  box #ivory
    participant “rApp” as rapp
  endbox
  box “Non-anchored functions in SMO/Non-RT RIC Framework”
  #cadetBlue
      participant “RAN OAM-related functions” as cmsp
  endbox
endbox
rapp −> cmsp: <<R1>> Write Configuration Changes request\n(rAppId,
queryCriteria,configuration changes information)
cmsp --> cmsp: AuthZ
note right
Check authorization in
Collaboration with SME functions
end note
cmsp --> cmsp: Validate request
cmsp −> rapp: <<R1>> Write Configuration Changes response\n
(Success/partialsucceess/failure, ConfigurationData)
@enduml
```

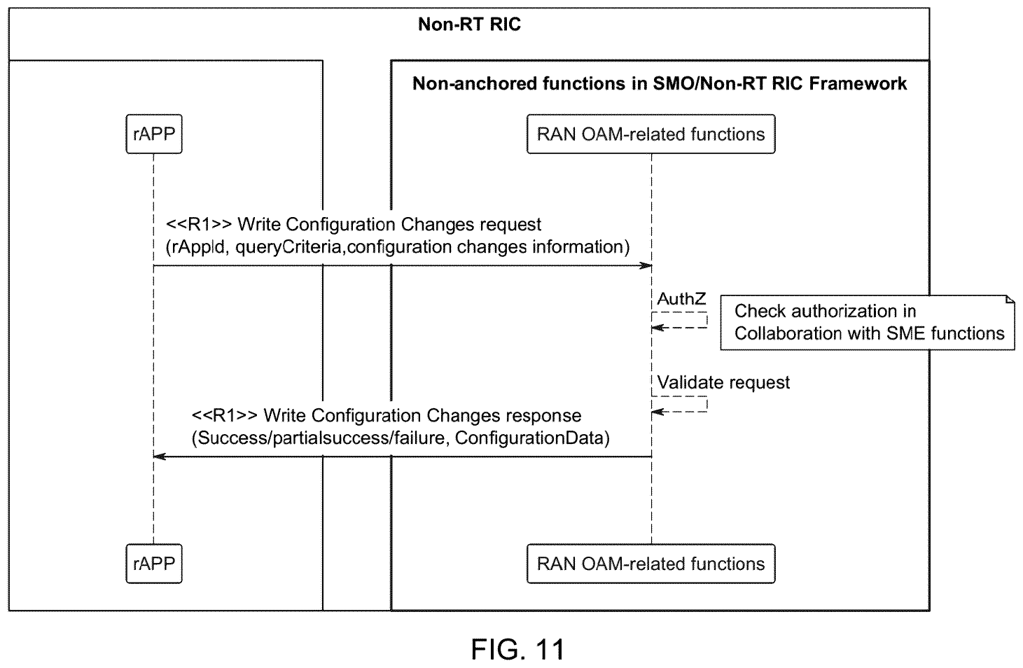

FIG. 11 refers to call flowchart between and an rApp and a NRT-RIC. Referring to the FIG. 11, FIG. 11 relates to original FIG. 8.3.4.1-1: Write Configuration Changes information use case flow diagram.

8.3.5 Required data: The Write Configuration Changes request for writing configuration changes information contains the rAppId, query criteria (including information about the related managed entities) and about the requested configuration changes information (list of attribute and desired values for managed entities). The Write configuration response includes written desired and unchanged configuration changes as a configuration data and, a success result only if all the desired configuration changes written in mentioned managed entities or a partial success result if partial but not all desired configuration changes written in mentioned managed entities because of a specified or unspecified reason or a failure if all desired configuration changes not written in mentioned managed entities because of a specified or unspecified reason.

NOTE: It is up to the design of the authorization mechanism whether the rAppId will be passed as a separate piece of information or will be embedded in or implied by the authorization information. <<end of change #1>>

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code it being understood that software and hardware may be designed to implement the systems and/or methods based on the description herein.

Various further respective aspects and features of embodiments of the present disclosure may be defined by the following items:

Item [1] An apparatus includes a non-real-time radio access network intelligence controller (NRT-RIC) configured to receive, from an rApp via an R1 interface between the rApp and the NRT-RIC framework, at least one request to write a configuration change to one or more O-RAN Operations and Maintenance (OAM) related functions; authorize the at least one request to write a configuration change to the one or more O-RAN OAM-related functions from the rApp; based on the authorizing, validate information provided by the at least one request to write a configuration change to one or more O-RAN OAM-related functions; based on the validating, create a job for writing the configuration changes based on the information provided by the at least one request to write a configuration change to one or more O-RAN OAM-related functions; and based on job creating, send via the NRT-RIC framework and the via an R1 interface, a job identifier comprising information about the job to the rApp.

Item [2] The apparatus according to Item [1], wherein: the at least one request to write a configuration change to the one or more O-RAN OAM-related functions comprising at least one information of an rApp identifier and one or more desired configuration changes for one or more O-RAN nodes within the O-RAN.

Item [3] The apparatus according to Item [1 or 2], wherein the apparatus configured to authorize the at least one request to write a configuration change to one or more O-RAN OAM-related functions from the rApp may be further configured to: authenticate, by a service management and exposure (SME) function of the NRT-RIC framework, the rApp from which the at least one request to write a configuration change to one or more O-RAN OAM-related functions was received; and based on the authenticating, verify, by the SME function of the NRT-RIC framework, the authorization of the rApp to request at least one request to write a configuration change to one or more O-RAN nodes.

Item [4] The apparatus according to any one of Items [1 to 3], wherein the apparatus configured to validate the information provided by the at least one request to write a configuration change to one or more O-RAN OAM-related functions may be further configured to: validate, by the one or more O-RAN OAM-related functions, at least one of a syntax and a message content of the at least one request to write a configuration change to one or more O-RAN OAM-related functions; and based on the validating, by the one or more O-RAN OAM-related functions, resolve conflicts between requests to a write configuration change from multiple rApps for similar O-RAN nodes.

Item [5] The apparatus according to any one of Items [1 to 4], wherein the apparatus configured to create a job for writing the configuration may be further configured to: based on the information provided by the at least one request to write a configuration change, determine, by the one or more O-RAN OAM-related functions, the availability of an E2 node and/or an open radio unit (E2/O-RU) to write the configuration change; and create, by the one or more O-RAN OAM-related functions, the job for writing the configuration changes based on the information provided by the at least one request to write a configuration change for the E2/O-RU independent of the availability of the E2/O-RU.

Item [6] The apparatus according to any one of Items [1 to 5], wherein the apparatus may be further configured to: based on sending a job identifier comprising information about the job to the rApp, receive from the rApp at least one job query via an R1 interface within the O-RAN architecture between rApps and the NRT-RIC framework.

Item [7] The apparatus according to Items [6], wherein the at least one job query may be at least one query for a notification of job status and for a query of a job result of the requested configuration change.

Item [8] A method includes: receiving, from an rApp via an R1 interface between the rApp and the NRT-RIC framework, at least one request to write a configuration change to one or more O-RAN Operations and Maintenance (OAM) related functions; authorizing, by the NRT-RIC framework, the at least one request to write a configuration change to the one or more O-RAN OAM-related functions from the rApp; based on the authorizing, validating, by the one or more O-RAN OAM-related functions, information provided by the at least one request to write a configuration change to one or more O-RAN OAM-related functions; based on the validating, creating, by the one or more O-RAN OAM-related functions, a job for writing the configuration changes based on the information provided by the at least one request to write a configuration change to one or more O-RAN OAM-related functions; and based on job creating, sending, by the one or more O-RAN OAM-related functions via the NRT-RIC framework and the via an R1 interface, a job identifier comprising information about the job to the rApp.

Item [9] The method according to Item [8], wherein: the at least one request to write a configuration change to the one or more O-RAN OAM-related functions comprising at least one information of an rApp identifier and one or more desired configuration changes for one or more O-RAN nodes within the O-RAN.

Item [10] The method according to Item [8 or 9], wherein the method may further include: authenticating, by a service management and exposure (SME) function of the NRT-RIC framework, the rApp from which the at least one request to write a configuration change to one or more O-RAN OAM-related functions was received; and based on the authenticating, verifying, by the SME function of the NRT-RIC framework, the authorization of the rApp to request at least one request to write a configuration change to one or more O-RAN nodes.

Item [11] The method according to any one of Items [8 to 10], wherein method may further include: validating, by the one or more O-RAN OAM-related functions, at least one of a syntax and a message content of the at least one request to write a configuration change to one or more O-RAN OAM-related functions; and based on the validating, by the one or more O-RAN OAM-related functions, resolving conflicts between requests to a write configuration change from multiple rApps for similar O-RAN nodes.

Item [12] The method according to any one of Items [8 to 11], wherein the method may further include: based on the information provided by the at least one request to write a configuration change, determining, by the one or more O-RAN OAM-related functions, the availability of an E2 node and/or an open radio unit (E2/O-RU) to write the configuration change; and creating, by the one or more O-RAN OAM-related functions, the job for writing the configuration changes based on the information provided by the at least one request to write a configuration change for the E2/O-RU independent of the availability of the E2/O-RU.

Item [13] The method according to any one of Items [8 to 12], wherein the method may further include: based on sending a job identifier comprising information about the job to the rApp, receiving from the rApp at least one job query via an R1 interface within the O-RAN architecture between rApps and the NRT-RIC framework.

Item [14] The method according to Item [13], wherein the at least one job query may be at least one query for a notification of job status and for a query of a job result of the requested configuration change.

Item [15] A non-transitory computer-readable recording medium having recorded thereon instructions executable by at least one processor to perform a method, the method includes: receiving, from an rApp via an R1 interface between the rApp and the NRT-RIC framework, at least one request to write a configuration change to one or more O-RAN Operations and Maintenance (OAM) related functions; authorizing, by the NRT-RIC framework, the at least one request to write a configuration change to the one or more O-RAN OAM-related functions from the rApp; based on the authorizing, validating, by the one or more O-RAN OAM-related functions, information provided by the at least one request to write a configuration change to one or more O-RAN OAM-related functions; based on the validating, creating, by the one or more O-RAN OAM-related functions, a job for writing the configuration changes based on the information provided by the at least one request to write a configuration change to one or more O-RAN OAM-related functions; and based on job creating, sending, by the one or more O-RAN OAM-related functions via the NRT-RIC framework and the via an R1 interface, a job identifier comprising information about the job to the rApp.

Item [16] The non-transitory computer-readable recording medium according to Item [15], wherein: the at least one request to write a configuration change to the one or more O-RAN OAM-related functions comprising at least one information of an rApp identifier and one or more desired configuration changes for one or more O-RAN nodes within the O-RAN.

Item [17] The non-transitory computer-readable recording medium according to Item [15 or 16], wherein the method may further include: authenticating, by a service management and exposure (SME) function of the NRT-RIC framework, the rApp from which the at least one request to write a configuration change to one or more O-RAN OAM-related functions was received; and based on the authenticating, verifying, by the SME function of the NRT-RIC framework, the authorization of the rApp to request at least one request to write a configuration change to one or more O-RAN nodes.

Item [18] The non-transitory computer-readable recording medium according to any one of Items [15 to 17], wherein method may further include: validating, by the one or more O-RAN OAM-related functions, at least one of a syntax and a message content of the at least one request to write a configuration change to one or more O-RAN OAM-related functions; and based on the validating, by the one or more O-RAN OAM-related functions, resolving conflicts between requests to a write configuration change from multiple rApps for similar O-RAN nodes.

Item [19] The non-transitory computer-readable recording medium according to any one of Items [15 to 18], wherein the method may further include: based on the information provided by the at least one request to write a configuration change, determining, by the one or more O-RAN OAM-related functions, the availability of an E2 node and/or an open radio unit (E2/O-RU) to write the configuration change; and creating, by the one or more O-RAN OAM-related functions, the job for writing the configuration changes based on the information provided by the at least one request to write a configuration change for the E2/O-RU independent of the availability of the E2/O-RU.

Item [20] The non-transitory computer-readable recording medium according to any one of Item [15 to 19], wherein the method may further include: based on sending a job identifier comprising information about the job to the rApp, receiving from the rApp at least one job query via an R1 interface within the O-RAN architecture between rApps and the NRT-RIC framework.

What is claimed is:

1. An apparatus comprising:
a non-real-time radio access network intelligence controller (NRT-RIC) configured to:
receive, from an rApp via an R1 interface between the rApp and the NRT-RIC framework, at least one request to write a configuration change to one or more O-RAN Operations and Maintenance (OAM) related functions;
authorize the at least one request to write a configuration change to the one or more O-RAN OAM-related functions from the rApp;
based on the authorizing, validate information provided by the at least one request to write a configuration change to one or more O-RAN OAM-related functions;
based on the validating, create a job for writing the configuration changes based on the information provided by the at least one request to write a configuration change to one or more O-RAN OAM-related functions; and
based on job creating, send via the NRT-RIC framework and the via an R1 interface, a job identifier comprising information about the job to the rApp.

2. The apparatus as claimed in claim 1, wherein:
the at least one request to write a configuration change to the one or more O-RAN OAM-related functions comprising at least one information of an rApp identifier and one or more desired configuration changes for one or more O-RAN nodes within the O-RAN.

3. The apparatus as claimed in claim 1, wherein the at least one processor configured to authorize the at least one request to write a configuration change to one or more O-RAN OAM-related functions from the rApp is further configured to:
authenticate, the rApp from which the at least one request to write a configuration change to one or more O-RAN OAM-related functions was received; and
based on the authenticating, verify the authorization of the rApp to request at least one request to write a configuration change to one or more O-RAN nodes.

4. The apparatus as claimed in claim 1, wherein the apparatus configured to validate the information provided by the at least one request to write a configuration change to one or more O-RAN OAM-related functions is further configured to:
validate at least one of a syntax and a message content of the at least one request to write a configuration change to one or more O-RAN OAM-related functions; and
based on the validating resolve conflicts between requests to a write configuration change from multiple rApps for similar O-RAN nodes.

5. The apparatus as claimed in claim 1, wherein the apparatus is configured to create a job for writing the configuration is further configured to:
based on the information provided by the at least one request to write a configuration change, determine the availability of an E2 node and/or an open radio unit (E2/O-RU) to write the configuration change; and
create the job for writing the configuration changes based on the information provided by the at least one request to write a configuration change for the E2/O-RU independent of the availability of the E2/O-RU.

6. The apparatus as claimed in claim 1, wherein the apparatus is further configured to:
based on sending a job identifier comprising information about the job to the rApp, receive from the rApp at least one job query via an R1 interface within the O-RAN architecture between rApps and the NRT-RIC framework.

7. The apparatus as claimed in claim 6, wherein the at least one job query is at least one query for a notification of job status and for a query of a job result of the requested configuration change.

8. A method comprising:
receiving, from an rApp via an R1 interface between the rApp and the NRT-RIC framework, at least one request to write a configuration change to one or more O-RAN Operations and Maintenance (OAM) related functions;
authorizing, by the NRT-RIC framework, the at least one request to write a configuration change to the one or more O-RAN OAM-related functions from the rApp;
based on the authorizing, validating, by the one or more O-RAN OAM-related functions, information provided by the at least one request to write a configuration change to one or more O-RAN OAM-related functions;
based on the validating, creating, by the one or more O-RAN OAM-related functions, a job for writing the configuration changes based on the information provided by the at least one request to write a configuration change to one or more O-RAN OAM-related functions; and
based on job creating, sending, by the one or more O-RAN OAM-related functions via the NRT-RIC framework and the via an R1 interface, a job identifier comprising information about the job to the rApp.

9. The method as claimed in claim 8, wherein:
the at least one request to write a configuration change to the one or more O-RAN OAM-related functions comprising at least one information of an rApp identifier and one or more desired configuration changes for one or more O-RAN nodes within the O-RAN.

10. The method as claimed in claim 8, wherein the method further comprises:
authenticating, by a service management and exposure (SME) function of the NRT-RIC framework, the rApp from which the at least one request to write a configuration change to one or more O-RAN OAM-related functions was received; and
based on the authenticating, verifying, by the SME function of the NRT-RIC framework, the authorization of the rApp to request at least one request to write a configuration change to one or more O-RAN nodes.

11. The method as claimed in claim 10, wherein method further comprises:
validating, by the one or more O-RAN OAM-related functions, at least one of a syntax and a message content of the at least one request to write a configuration change to one or more O-RAN OAM-related functions; and
based on the validating, by the one or more O-RAN OAM-related functions, resolving conflicts between requests to a write configuration change from multiple rApps for similar O-RAN nodes.

12. The method as claimed in claim 8, wherein the method further comprises:
based on the information provided by the at least one request to write a configuration change, determining, by the one or more O-RAN OAM-related functions, the availability of an E2 node and/or an open radio unit (E2/O-RU) to write the configuration change; and
creating, by the one or more O-RAN OAM-related functions, the job for writing the configuration changes based on the information provided by the at least one request to write a configuration change for the E2/O-RU independent of the availability of the E2/O-RU.

13. The method as claimed in claim 8, wherein the method further comprises:
based on sending a job identifier comprising information about the job to the rApp, receiving from the rApp at least one job query via an R1 interface within the O-RAN architecture between rApps and the NRT-RIC framework.

14. The method as claimed in claim 13, wherein the at least one job query is at least one query for a notification of job status and for a query of a job result of the requested configuration change.

15. A non-transitory computer-readable recording medium having recorded thereon instructions executable by at least one processor to perform a method, the method comprising:
receiving, from an rApp via an R1 interface between the rApp and the NRT-RIC framework, at least one request to write a configuration change to one or more O-RAN Operations and Maintenance (OAM) related functions;
authorizing, by the NRT-RIC framework, the at least one request to write a configuration change to the one or more O-RAN OAM-related functions from the rApp;
based on the authorizing, validating, by the one or more O-RAN OAM-related functions, information provided by the at least one request to write a configuration change to one or more O-RAN OAM-related functions;
based on the validating, creating, by the one or more O-RAN OAM-related functions, a job for writing the configuration changes based on the information provided by the at least one request to write a configuration change to one or more O-RAN OAM-related functions; and
based on job creating, sending, by the one or more O-RAN OAM-related functions via the NRT-RIC framework and the via an R1 interface, a job identifier comprising information about the job to the rApp.

16. The non-transitory computer-readable recording medium as claimed in claim 15, wherein:
the at least one request to write a configuration change to the one or more O-RAN OAM-related functions comprising at least one information of an rApp identifier and one or more desired configuration changes for one or more O-RAN nodes within the O-RAN.

17. The non-transitory computer-readable recording medium as claimed in claim 15, wherein the method further comprises:
authenticating, by a service management and exposure (SME) function of the NRT-RIC framework, the rApp from which the at least one request to write a configuration change to one or more O-RAN OAM-related functions was received; and
based on the authenticating, verifying, by the SME function of the NRT-RIC framework, the authorization of the rApp to request at least one request to write a configuration change to one or more O-RAN nodes.

18. The non-transitory computer-readable recording medium as claimed in claim 17, wherein method further comprises:
validating, by the one or more O-RAN OAM-related functions, at least one of a syntax and a message content of the at least one request to write a configuration change to one or more O-RAN OAM-related functions; and
based on the validating, by the one or more O-RAN OAM-related functions, resolving conflicts between requests to a write configuration change from multiple rApps for similar O-RAN nodes.

19. The non-transitory computer-readable recording medium as claimed in claim 15, wherein the method further comprises:
based on the information provided by the at least one request to write a configuration change, determining, by the one or more O-RAN OAM-related functions, the availability of an E2 node and/or an open radio unit (E2/O-RU) to write the configuration change; and
creating, by the one or more O-RAN OAM-related functions, the job for writing the configuration changes based on the information provided by the at least one request to write a configuration change for the E2/O-RU independent of the availability of the E2/O-RU.

20. The non-transitory computer-readable recording medium as claimed in claim 15, wherein the method further comprises:
based on sending a job identifier comprising information about the job to the rApp, receiving from the rApp at least one job query via an R1 interface within the O-RAN architecture between rApps and the NRT-RIC framework.
